(19) United States
(12) Patent Application Publication
(10) Pub. No.: US 2026/0264590 A1
(43) Pub. Date: Sep. 10, 2026

(54) RETRACTABLE AUTOMOBILE SEAT GUARD

(71) Applicant: McMurray Fabrics Inc., Aberdeen, NC (US)

(72) Inventor: Bradley John Roback, Carthage, NC (US)

(21) Appl. No.: 19/560,351

(22) Filed: Mar. 9, 2026

Related U.S. Application Data
(60) Provisional application No. 63/769,271, filed on Mar. 10, 2025.

(51) Int. Cl. B60N 2/60; B65H 75/42; B65H 75/44; B65H 75/48

(52) U.S. Cl. CPC B60N 2/6009; B60N 2/6027; B65H 75/425; B65H 75/4471; B65H 75/486; B65H 2301/4128

(57) ABSTRACT

A vehicle seat protection device and methods for protecting vehicle seats are provided herein. The vehicle seat protection device includes a housing containing a retraction device with a first roller and a first spring. A first panel is coupled to the first roller and stored in the housing and a second panel is also at least partially disposed in the housing when in a retracted state. The first spring applies rotational force to bias the first panel into the retracted state. The first panel includes at least one attachment feature configured to attach to a vehicle seat back portion. When attached, the first panel extends from the housing in an extended state to cover the vehicle seat back portion. The device enables quick installation, quick deployment of protective panels to cover vehicle seat surfaces, compact storage when not in use, and provides protection against damage and wear.

### CROSS-REFERENCE TO RELATED APPLICATIONS

This application claims priority to U.S. provisional Patent Application No. 63/769,271, filed Mar. 10, 2025, entitled “Retractable Automobile Seat Guard”, which is hereby incorporated by reference in its entirety.

### FIELD OF THE DISCLOSURE

Embodiments of the present disclosure relate generally to vehicle accessories and, more particularly, to protective cover devices and methods for securing and organizing protective panels within a vehicle interior.

### BACKGROUND OF THE DISCLOSURE

In vehicle interiors, seats are often exposed to wear and damage from various sources, including pets during transport. Many pet owners regularly travel with their pets in vehicles, making seat protection a common concern. While various solutions exist, such as seat covers or barriers, these often fall short of meeting protection needs while providing an easy to use system.

Traditional methods of protecting vehicle seats can present several challenges. Universal seat covers may not properly fit different seat configurations, while barriers can be difficult to install and remove. Vehicle owners frequently need to accommodate both human passengers and various cargo, including pets, fishing equipment, dirty clothes and footwear, sports equipment, and other items that could soil or damage upholstery. This creates additional challenges, as existing protection systems may not easily adapt to partial seat coverage needs. Access to vehicle features, such as seatbelts, can also be difficult by currently available seat covers, making it hard to properly secure pets during travel.

Storage and deployment of existing seat protection solutions can also be problematic. Covers often become wrinkled or damaged when stored and may occupy significant space in the vehicle. The process of installing and removing traditional covers typically requires multiple steps, making quick changes between configurations time-consuming and sometimes difficult.

Consequently, there is a need for an improved vehicle seat protection system that addresses these challenges, including providing ease of use. Accordingly, various embodiments detailed herein provide improved devices and methods for protecting vehicle seats.

### BRIEF SUMMARY OF THE DISCLOSURE

Embodiments of the present disclosure provide for various devices and methods that address the noted difficulties and challenges associated with protecting vehicle seats. In this regard, various embodiments of the present disclosure provide systems for protecting vehicle seats in a way that enables for easy installation, removal, cleaning, and adjustment when the user needs to configure the vehicle interior for different transportation needs.

Example devices and methods disclosed herein include a protection device with a housing that enables a user to adjust and secure protective panels within the vehicle. The protection device may comprise a housing containing retractable panels that can be extended to cover vehicle seat surfaces. Example embodiments of the protection device may accommodate various vehicle configurations and seating arrangements, offering solutions for different applications. The device enables quick and easy installation and removal without specialized tools. The panels can be extended to provide coverage while, in some embodiments, maintaining access to vehicle safety features. In some embodiments, the device can be easily uninstalled and cleaned, such as by rinsing and/or washing the panels.

In an example embodiment, a vehicle seat protection device is provided. The vehicle seat protection device includes a housing; a first panel at least partially disposed in the housing when in a retracted state; a second panel at least partially disposed in the housing when in the retracted state; and a retraction device disposed in the housing. The retraction device comprises a first roller, the first panel coupled to the first roller in the retracted state; and a first spring configured to apply a first rotational force on the first roller that biases the first panel into the retracted state. The vehicle seat protection device includes at least one first attachment feature coupled to the first panel, wherein the at least one first attachment feature is configured to attach to an upper portion of a vehicle seat back portion, and wherein, when the at least one first attachment feature is attached to the upper portion of the vehicle seat back portion, the first panel is in the extended state and covers a front surface of the vehicle seat back portion.

In some embodiments, the vehicle seat protection device further comprises at least one second attachment feature coupled to the second panel, wherein the at least one second attachment feature is configured to attach to a lower portion of the vehicle seat back portion, wherein, when the at least one second attachment feature is attached to the lower portion of the vehicle seat back portion, the second panel is in the extended state and covers a top surface of the vehicle seat back portion.

In some embodiments, the retraction device further comprises a second roller disposed in the housing, the second panel coupled to the second roller in the retracted state; and a second spring, the second spring configured to apply a second rotational force on the second roller that biases the second panel into the retracted state. In some embodiments, the first roller is disposed in the housing adjacent to the second roller.

In some embodiments, the first panel and the second panel comprise one or more access openings configured to provide access to restraint attachment points, the one or more access openings aligned with one or more vehicle seat buckles or latches when the first panel is deployed, the one or more access openings comprising closeable slits in the first panel.

In some embodiments, the vehicle seat protection device further comprises a locking mechanism configured to selectively prevent retraction of at least one of the first panel or the second panel when in the extended state; and a button that engages with the locking mechanism to prevent the retraction device from retracting the first panel and the second panel.

In some embodiments, the vehicle seat protection device further comprises a two-stage extension system, wherein the two-stage extension system comprises: a first extension stage, wherein the first panel and the second panel extend to a first position and wherein the first panel and the second panel are configured to automatically retract when released from the first position; and a second extension stage, wherein the first panel and the second panel extend beyond the first position to a second position, wherein a locking feature engages with the retraction device to prevent automatic retraction of the first panel and second panel in the second position.

In some embodiments, the housing comprises at least one housing attachment feature configured to secure the housing between a vehicle seat back portion and a vehicle seat bottom portion.

In some embodiments, the first roller of the retraction device is configured to retract both the first panel and the second panel.

In some embodiments, the housing comprises a first handle for deploying the first panel and a second handle for deploying the second panel, the first handle configured to simultaneously deploy both the first panel and the second panel.

In some embodiments, the first panel and the second panel comprise a material, wherein the material comprises at least one of nylon, polyester, canvas, vinyl, leather, polypropylene, or other polymers.

In some embodiments, the housing comprises a first aperture configured to allow the first panel to translate therethrough; and a second aperture configured to allow the second panel to translate therethrough, the first aperture disposed between the second aperture and a vehicle seat back portion.

In another example embodiment, a vehicle seat protection device is provided. The vehicle seat protection device comprises a housing; a first panel disposed in the housing while in a retracted state; a second panel disposed in the housing while in a retracted state; and a retraction device disposed in the housing. The retraction device comprises a first roller coupled to the first panel; and a first spring configured to apply a first rotational force to the first roller that biases the first panel into the retracted state. The retraction device further comprises a second roller coupled to the second panel; and a second spring configured to apply a second rotational force to the second roller that biases the second panel into the retracted state. The vehicle seat protection device further comprises at least one first attachment feature coupled to the first panel, wherein the at least one first attachment feature is configured to attach to an upper portion of a vehicle seat back portion when the first panel is in the extended state, wherein the at least one first attachment feature is attached to the upper portion of the vehicle seat back portion and covers a front surface of the vehicle seat back portion when the first panel is in the extended state; and at least one second attachment feature coupled to the second panel, wherein the at least one second attachment feature is configured to attach to a lower portion of the vehicle seat back portion, wherein, when the at least one second attachment feature is attached to the lower portion of the vehicle seat back portion, the second panel is in the extended state and covers a top surface of the vehicle seat back portion.

In some embodiments, the housing comprises a first aperture configured to allow the first panel to translate therethrough; and a second aperture configured to allow the second panel to translate therethrough, the first aperture disposed between the second aperture and the vehicle seat back portion.

In some embodiments, the housing comprises at least one housing attachment feature configured to attach to at least one anchoring point of the vehicle seat back portion.

In some embodiments, the first panel and the second panel are in an adjacent spiral configuration within the housing when in the retracted state.

In another example embodiment, a vehicle seat assembly is provided. The vehicle seat assembly comprises a vehicle seat comprising a seat back portion and a seat bottom portion; and a seat protection device positioned between the seat back portion and the seat bottom portion. The seat protection device comprises a housing; a retraction device; a first panel at least partially stored in the housing when in a retracted state, the first panel coupled to the retraction device, wherein the first panel is configured to extend from the housing when in an extended state and retract into the housing when in the retracted state, the first panel covering a front surface of the vehicle seat back portion in the extended state; a second panel at least partially stored in the housing when in the retracted state, the second panel coupled to the retraction device, wherein the second panel is configured to extend from the housing when in the extended state and retract into the housing when in the retracted state, the second panel covering a top surface of the vehicle seat bottom portion in the extended state; at least one first attachment feature configured to attach to an upper portion of the vehicle seat back portion when in the extended state; and at least one second attachment feature, configured to attach to the vehicle seat bottom portion, when in the extended state.

In some embodiments, the retraction device is disposed in the housing and the retraction device comprises a first roller coupled to the first panel; a first spring configured to apply a first rotational force to the first roller that biases the first panel into the retracted state; a second roller coupled to the second panel; and a second spring configured to apply a second rotational force to the second roller that biases the second panel into the retracted state.

In some embodiments, the housing comprises a first aperture configured to allow the first panel to translate therethrough; and a second aperture configured to allow the second panel to translate therethrough, the first aperture disposed between the second aperture and the vehicle seat back portion.

In some embodiments, the first panel and the second panel are configured to be independently deployable from the housing.

### BRIEF DESCRIPTION OF THE DRAWINGS

Having thus described embodiments of the present disclosure in general terms, reference will now be made to the accompanying drawings, which are not necessarily drawn to scale, and wherein:

FIG. 1 illustrates a side view of a vehicle with a vehicle seat protection device installed, in accordance with some embodiments disclosed herein;

FIG. 2A illustrates a perspective view of a vehicle bench with a protection device positioned between seat back and seat bottom portions, in accordance with some embodiments discussed herein;

FIG. 2B illustrates the protection device of FIG. 2A with protective panels fully extended to cover the seat back and seat bottom portions of the vehicle bench, in accordance with some embodiments discussed herein;

FIG. 2C illustrates a perspective view of an example protection device housing with housing attachment features, in accordance with some embodiments discussed herein;

FIG. 2D illustrates a cross-sectional side view of the protection device of FIG. 2C showing a single roller configuration, in accordance with some embodiments discussed herein;

FIG. 2E illustrates a cross-sectional side view of another example protection device showing a dual roller configuration, in accordance with some embodiments discussed herein;

FIG. 2F illustrates the protective panels of the protection device of FIG. 2A in an extended state, such as for maintenance, in accordance with some embodiments discussed herein;

FIG. 3A illustrates a configuration of another example protection device covering a single seat position of the vehicle bench, in accordance with some embodiments discussed herein;

FIG. 3B illustrates a configuration of another example protection device covering two adjacent seat positions of the vehicle bench, in accordance with some embodiments discussed herein;

FIG. 4A illustrates an example protection device with protective panels extended, showing access opening locations, in accordance with some embodiments discussed herein;

FIG. 4B illustrates a restraint attachment engaged with a vehicle latch through an access opening of the protection device, in accordance with some embodiments discussed herein;

FIG. 5 shows a flowchart of an example method for installing the protection device;

FIGS. 6A-6E illustrate a sequence of deploying an example protection device from an initial configuration to a fully installed configuration, in accordance with some embodiments discussed herein;

FIG. 7 illustrates an internal cross-sectional side view of another example vehicle seat protection device showing a dual roller configuration, in accordance with some embodiments discussed herein;

FIG. 8A illustrates a perspective front view of another example vehicle seat protection device, in accordance with some embodiments discussed herein;

FIG. 8B illustrates an internal cross-sectional side view of the protection device of FIG. 8A, showing a dual roller configuration, in accordance with some embodiments discussed herein;

FIG. 8C illustrates a rear perspective view of the protection device of FIG. 8A, illustrating example housing attachment brackets, in accordance with some embodiments discussed herein; and

FIGS. 9A-9C illustrate deployment of the example protection device of FIGS. 8A-8C from an initial configuration to a fully installed configuration, in accordance with some embodiments discussed herein.

### DETAILED DESCRIPTION

Exemplary embodiments of the present disclosure will be described more fully hereinafter with reference to the accompanying drawings, in which some, but not all embodiments of the present disclosure are shown. Indeed, the present disclosure may be embodied in many different forms and should not be construed as limited to the exemplary embodiments set forth herein; rather, these embodiments are provided so that this disclosure will satisfy applicable legal requirements. Like reference numerals refer to like elements throughout.

Example devices and methods according to the present disclosure enable users to protect vehicle seats, such as during pet transport. In some embodiments, example devices are able to cover vehicle seat surfaces using retractable panels that can be configured for different seating arrangements. Further, in some embodiments, example devices may additionally prevent damage to vehicle upholstery while allowing access to necessary vehicle features.

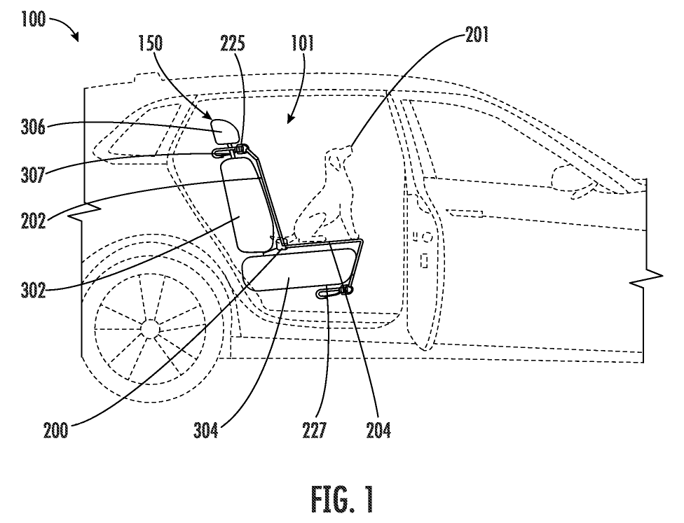

FIG. 1 illustrates a portion of a vehicle 100 that includes a seating area 101 with a vehicle bench 150 that includes a seat back portion 302 and a seat bottom portion 304. The seat back portion 302 extends vertically and provides support for a passenger's back (e.g., via a front surface of the seat back portion 302), while the seat bottom portion 304 extends horizontally to support the passenger's weight (e.g., via a top surface of the seat bottom portion 304). Vehicle seats also commonly include headrest posts 307 that extend upward from the seat back portion 302 to support a headrest 306. Vehicle seats may also include various anchor points for securing accessories or safety devices. These anchoring points may include child seat anchors, such as LATCH (Lower Anchors and Tethers for Children) anchors, ISOFIX (International Standard Organization Fix) anchors or other similar attachment points positioned between the seat back portion 302 and seat bottom portion 304. These standardized anchoring points provide secure attachment locations for various vehicle accessories. Notably, while a vehicle bench with multiple seats is illustrated and discussed herein, one of ordinary skill in the art in view of this disclosure would appreciate that various embodiments are usable with a single vehicle seat, such as a “captain’s chair” or other vehicle seat configurations.

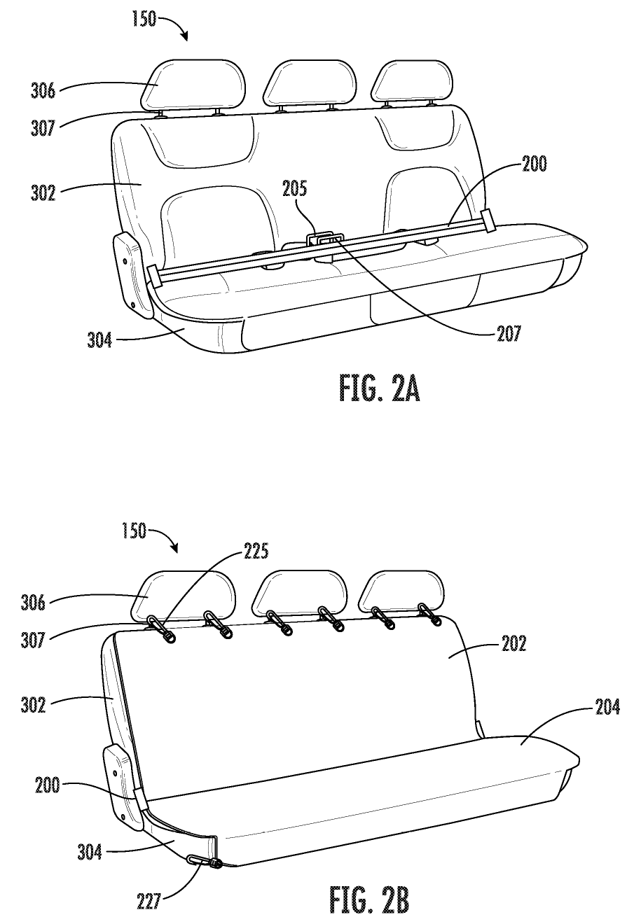

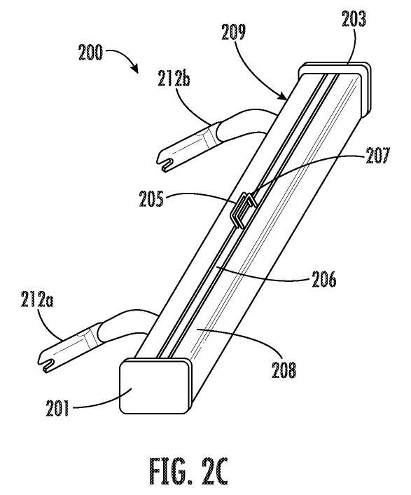

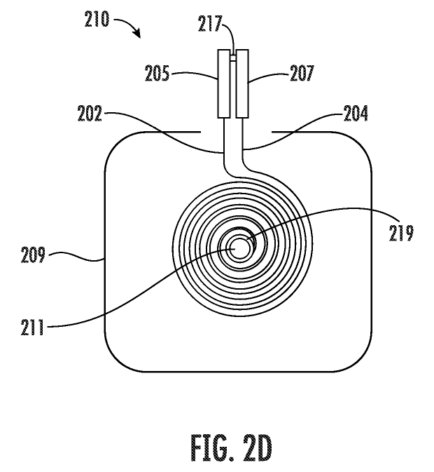

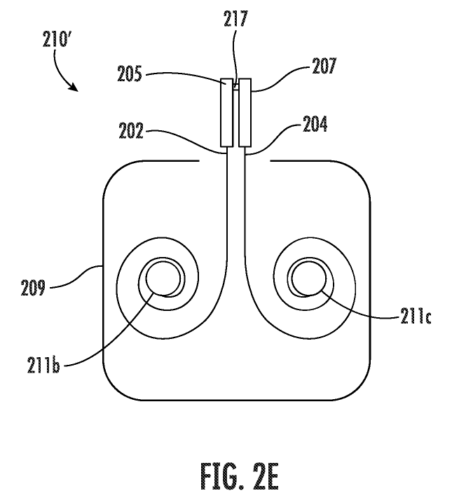

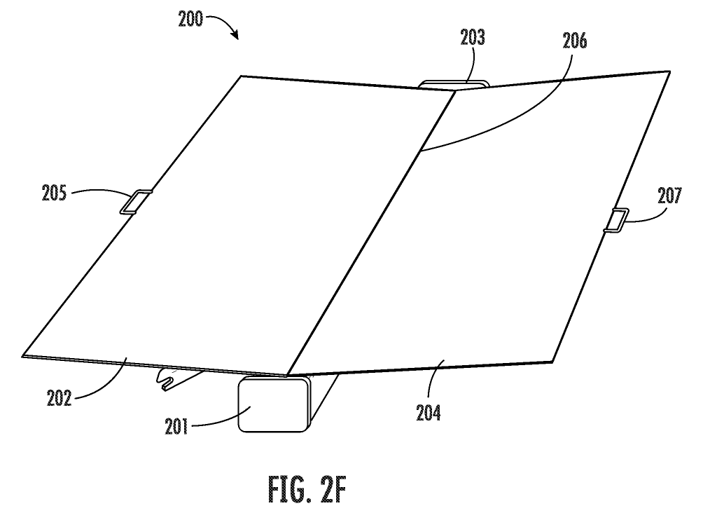

A protection device 200 to protect the vehicle seat, such as from stains, damage, and wear, is configured to utilize existing vehicle features for installation. The vehicle seat protection device 200 comprises a housing 209 (shown in FIG. 2C) that may be positioned between the seat back portion 302 and seat bottom portion 304. In some embodiments, the housing may take different forms, including but not limited to, a carrier, a cassette, a partially enclosed housing, a structural frame, a support structure, an enclosure, or any similar structure capable of containing and dispensing the panels. In some embodiments, the housing provides sufficient support to maintain the alignment of internal components while enabling extension and retraction of the protective panels. The housing 209 can be secured using a housing attachment feature such as clips or hooks that attach to the vehicle's LATCH or ISOFIX anchors or similar attachment points. This positioning enables the device 200 to remain stable and in position when in use. From the housing, a first panel 202 extends upward to cover the seat back portion 302. The first panel 202, in some embodiments, comprises a durable material with sufficient structural integrity to maintain proper coverage while providing protection, such as from pet claws, water, mud, dirt, and other potential sources of damage. In some embodiments, the panel may be configured to conform in some amount, such as to contours of the seat portions, the panel is configured to maintain a relatively stiff flat protective surface that spans across the seat back. The first panel 202 may be constructed from various materials including, but not limited to synthetic material, fabric, weatherproof material, water-resistant material, and/or multi-layer protective compositions, such materials being formed of, for example, nylon, polyester, polypropylene, canvas, vinyl, leather, or other polymers alone or in combination. The first panel 202 includes one or more attachment features 225 configured to secure to the headrest posts 307. These attachment features 225 may comprise adjustable straps, clips, or hooks that can accommodate various headrest post configurations and sizes. The attachment to the headrest posts 307 maintains proper positioning of the first panel 202 during use and ensures consistent coverage of the seat back portion 302.

A second panel 204 extends forward from the housing to cover the seat bottom portion 304. Similar to the first panel, the second panel 204 comprises materials selected for durability and protection while maintaining comfort for pet transport. The second panel 204 may utilize the same or different materials as the first panel 202, depending on specific protection requirements. The second panel 204 includes one or more attachment features 227 configured to secure the panel. These attachment features 227 may engage with the underside of the seat bottom portion 304 or connect to existing seat mounting points. The attachment features 227 can be configured as hooks, clips, or other fastening mechanisms that provide secure attachment while enabling for easy installation and removal.

In some embodiments, for vehicles with limited access to suitable attachment points, the system may be supplied with or compatible with a supplemental hardware kit for securing one or more of the panels, such as the second panel 204. Such a kit may include, for example, plastic or metal brackets that can be secured to the underside of the seat frame using screws, bolts, or other fasteners. These brackets may provide dedicated mounting points configured specifically to engage with the attachment features 227 of the second panel 204. The hardware kit may offer multiple mounting options to accommodate different vehicle seat designs, ensuring the protection device can be effectively secured even in vehicles without standard attachment points. Installation of such hardware can be performed as a one-time setup, enabling for quick attachment and detachment of the panel thereafter.

As shown in FIG. 1, a pet can be positioned on the protected seat surfaces. While a pet is illustrated, the vehicle seat protection device 200 may also protect vehicle seats from various cargo items that could potentially damage or soil upholstery, such as but not limited to, fishing equipment, dirty clothes and footwear, camping gear, sporting equipment, tools, gardening supplies, or groceries. The vehicle seat protection device 200 enables various cargo items, including pets, to be transported while preventing contact between the items and the actual seat surfaces. In some embodiments, the panels provide complete coverage of the seat surfaces while maintaining proper positioning through their respective attachment features. In some embodiments, such as depending on seat configuration/design, the panels may provide near complete or less coverage, such as a small portion of the seat may remain exposed. However, the panel still provides significant protection even in such circumstances. The vehicle seat protection device 200 may also be installed in various vehicle configurations, including different seat styles and sizes. The vehicle seat protection device 200 enables for adaptation to both individual seats and bench-style seating arrangements. The materials and construction of the panels permit them to adapt to different seat contours while maintaining protective coverage.

In some embodiments, the panels may include additional features such as reinforced wear zones in areas of high pet activity, water-resistant barriers, or comfort-enhancing surface treatments. The panels may also incorporate various colorways or patterns to complement vehicle interior designs while maintaining their protective functionality.

In some embodiments, the panels may include customized graphics, logos, or images on their outward-facing surfaces. These visual elements may include pictures, team logos, decorative patterns, personalized text, or other custom designs. Such customization enables users to personalize their vehicle interior when the panels are deployed. The visual elements may be applied through various techniques such as printing, formation during manufacturing, embroidery, or heat transfer such as depending on the panel material.

To better illustrate the protection device's installation and deployment in a vehicle, FIGS. 2A-2F provide detailed views of the device's positioning, coverage capabilities when fully deployed, and the internal components that enable its functionality.

FIGS. 2A and 2B illustrate the vehicle seat protection device 200 as installed in a vehicle bench seat 150. Referring first to FIG. 2A, the vehicle seat protection device 200 is positioned between the seat back portion 302 and seat bottom portion 304 of the vehicle bench seat 150. This positioning allows the vehicle seat protection device 200 to be easily installed while still permitting use of the vehicle bench seat.In some embodiments, the vehicle seat protection device 200 may utilize the vehicle's existing anchor points for secure installation with the device’s latch clips. The vehicle seat protection device 200 includes a first handle 205 and a second handle 207 that facilitate deployment of the protective panels. In some embodiments, the first handle 205 is configured for initial deployment of both panels, while the second handle 207 enables separate positioning of the second panel. These handles may take various forms. The handles may be constructed of durable materials such as reinforced plastic or metal components to withstand repeated use. Alternatively, the handles could be implemented as flexible fabric straps, textile loops, pull tabs, cord of pull strings that may have grip elements, recesses for finger access in the panel material, or pull rings.

The handles 205, 207 may include locking mechanisms that temporarily couple the handles together during initial deployment. This coupling enables both panels to move upward simultaneously when the first handle 205 is pulled. The locking mechanism may comprise mechanical latches, magnetic connections, or other releasable fastening systems.

FIG. 2B illustrates the vehicle seat protection device 200 in its fully deployed configuration. The first panel 202, shown in an extended state, extends upward from the housing to cover the seat back portion 302, while the second panel 204, shown in an extended state, extends forward to cover the seat bottom portion 304. The deployment process begins by pulling the handles upward, which releases both panels from their stored position (e.g., retracted states) within the housing 209.

During deployment, the first panel 202 is secured to the headrest posts 307 using attachment features 225. These attachment features 225 may be configured as adjustable straps, clips, or hooks that accommodate various headrest post configurations. Once the first panel 202 is secured to the headrest posts 307, the attachment maintains proper tension on the panel, ensuring consistent coverage of the seat back portion. The second handle 207 can then be released from its coupling with the first handle 205. This release enables the second panel 204 to be guided downward independently, conforming to the seat bottom portion 304. The second panel 204 includes attachment features 227 that secure to anchor points beneath the seat bottom portion, maintaining proper positioning during use. Notably, while the illustrated embodiment describes the second panel being initially secured to the first panel, in other embodiments, the panels may not be so attached and could be independently controlled.

To better understand the construction of the vehicle seat protection device 200, FIGS. 2C-2D illustrate an example housing and the internal components. FIG. 2C shows the housing with integrated mounting and deployment features. While illustrated as an enclosure, the housing 209 shown may be a carrier, a partially enclosed housing, a structural frame, a cassette, or other support structure. The housing 209 extends from a first end 201 to a second end 203, sized to accommodate installation between vehicle seat portions. In some embodiments, such as in addition to the housing or as an alternative to having a housing, one or both of the ends 201 or 203 may provide necessary support for the internal retraction mechanism such as a retraction device 210 which will be discussed in more detail FIG. 2D. In this regard, at least one of the ends may be configured to store spring components that provide the retraction enabling for controlled extension and retraction of the panels. The housing 209 may be constructed from durable materials such as molded plastic or aluminum to withstand repeated use while maintaining structural integrity. A top surface 208 of the housing includes an opening 206 that extends along the length of the housing. This opening 206 is configured to enable smooth deployment and retraction of the protective panels while maintaining proper alignment during operation. The edges of opening 206 may include guide elements that help direct panel movement and prevent binding during use. The housing 209 also incorporates latch clips 212a and 212b positioned near the ends 201, 203 of the housing 209. These clips 212a, 212b are configured to engage with vehicle LATCH anchors or other vehicle anchoring points, providing secure attachment between seat portions. The clips 212a, 212b may include spring-loaded mechanisms that maintain consistent engagement pressure while enabling for easy installation and removal.

In some embodiments, the latch clips 212a and 212b may be adjustable to accommodate different vehicle anchor positions. This adjustability could include sliding mounts or multiple mounting positions along the housing. The clips may also incorporate visual or tactile indicators to confirm proper engagement with vehicle anchors.

The vehicle seat protection device 200 can be configured as a universal attachment system. Universal configurations may utilize standardized connection points found in most modern vehicles, providing broad compatibility across multiple vehicle makes and models. Additionally, or alternatively, in some embodiments, completely customized versions of the vehicle seat protection device 200 may be produced for specific vehicle models, with attachment features configured to match the exact dimensions and corresponding connection points and/or anchor positions of particular vehicles. In this regard, the vehicle manufacturer may specifically design connection points and means to work with the protection device for installation and use within the particular vehicle.

In some embodiments, alternative mounting systems may include adjustable brackets, hook systems, or other attachment mechanisms suited for vehicles without LATCH, ISOFIX, or other similar anchor points. These systems could incorporate tension adjusters to maintain proper positioning regardless of seat design or materials.

The housing dimensions may be configured for different vehicle applications. The length may vary to accommodate single-seat, dual-seat, or full-bench coverage, while the cross-sectional dimensions enable for installation without interfering with seat operation or passenger comfort. The housing may also include contoured surfaces that complement vehicle seat shapes for passenger comfort when the device is not in use.

Handles 205 and 207 extend from the panels through opening 206. These handles may be ergonomically configured for comfortable grip and operation. The handle positioning enables users to maintain control during panel deployment while providing convenient access when the device is installed.

FIG. 2D reveals the internal configuration of housing 209, showing a retraction device 210 that includes a roller 211. This roller 211 spans the length of the housing 209 and provides the foundation for panel storage and deployment. The roller 211 may be supported by bearing assemblies that ensure smooth rotation while maintaining proper alignment.

The retraction device 210 operates through an integrated system of roller 211 and a spring mechanism 219 to manage panel movement. Various spring configurations may be employed. In some embodiments, a torsional spring, which applies rotational force when twisted may be used. As the panels are extended, the torsional spring is wound, storing energy that is later used for retraction. In some embodiments, a clock spring (also known as a spiral spring) similar to those used in retractable tape measures may be employed. Clock springs include a spiral of spring steel that provides consistent tension throughout its range of extension, making them particularly suitable for maintaining even panel tension. In some embodiments, other spring options may be employed, such as but not limited to, constant-force springs, rotational springs, or power springs.

The spring mechanism 219, in some embodiments, may be mounted within one of the end portions 201, 203 of the housing 209, with one end of the spring anchored to the housing and the other end connected to the roller 211. This enables the spring to apply rotational torque to the roller, driving retraction of the panels when they are released. In some embodiments, springs may be mounted at both ends to provide balanced retraction force, particularly for wider housing configurations. In some embodiments, the housing may be minimized to a frame structure comprising primarily of the two end portions 201 and 203 with minimal structural connection between the two ends. The end portions 201 and 203 may provide enough structural integrity to support the roller 211 and comprise the spring mechanisms, while the space between the ends remains largely open. This approach reduces material usage and weight while preserving the functionality of the protection device. The end portions may comprise the bearing assemblies for the roller 211, and at least one end portion houses the spring mechanism that provides retraction force.

When panels are retracted, both first panel 202 and second panel 204 wrap around roller 211 in a layered spiral configuration. For example, the first panel 202 wraps on an outer layer while the second panel 204 wraps in an inner layer against the roller surface, enabling for compact storage within housing 209. The first panel 202 and the second panel 204 may be of substantially similar lengths to facilitate equal wrapping around the roller 211.

In some embodiments, such as when extension and retraction of the panels is separate, the panels may be of different lengths to accommodate specific vehicle configurations. For vehicles with taller seat backs or deeper seat bottoms, the panel lengths may be customized accordingly, while still maintaining compatible operation with the roller.

During deployment, as a user pulls handles 205 and 207, the panels unwind from roller 211 through opening 206. The spring mechanism maintains back-tension during this unwinding process, ensuring the panels remain taut and preventing uncontrolled unfurling. As the panels extend, roller 211 rotates against the spring force, storing potential energy for later retraction. The unwinding sequence may occur in phases. Initially, both panels may move together due to their layered storage configuration and coupled handles. The outer layer (first panel 202) naturally deploys first while maintaining connection to the inner layer (second panel 204). This synchronized movement continues until the first panel 202 is secured to the headrest posts.

When retracting, the spring mechanism uses its stored energy to rotate roller 211, drawing the panels back into the housing. The roller's surface may include guide features that ensure proper rewinding of the panels in their respective layers. The second panel 204 wraps first, followed by first panel 202, maintaining their original layered configuration. To control this movement, the roller assembly may incorporate a ratcheting mechanism. This mechanism engages at set intervals during deployment, enabling users to stop panel extension at various positions. When retraction is desired, the ratchet can be disengaged, enabling the spring mechanism to rotate roller 211 and rewind the panels. The interface between the roller 211 and the panels can incorporate various attachment methods. These may include mechanical fasteners, bonded connections, or channeled inserts that secure the panel material while enabling for maintenance or replacement if needed.

The handles 205 and 207 may include coupling elements 217 that enable simultaneous panel deployment. In some embodiments, these coupling elements could comprise mechanical latches, magnets, or other releasable connections that temporarily join the handles during initial deployment.

In some embodiments, the coupling elements 217 may include push-button releases or similar mechanisms that enable for simple handle separation when transitioning between panel positions. The coupling system ensures reliable operation while maintaining user convenience.

In some embodiments, housing 209 may also include internal guide channels that direct panel movement during deployment and retraction. These channels help maintain proper panel alignment while preventing contact with housing components that could cause wear or damage.

In some embodiments, the retraction device 210 may incorporate a system that provides stepped deployment positions. This system enables users to extend the panels to various predetermined positions and lock them in place. This mechanism, for example, can be released through a button or lever integrated into the housing, providing controlled retraction when desired.

Moving from this single roller configuration, FIG. 2E demonstrates an alternative embodiment utilizing dual rollers for independent panel operation. FIG. 2E illustrates an alternative embodiment of the retraction device 210' utilizing a dual roller configuration. In this arrangement, first panel 202 wraps around roller 211b while second panel 204 independently wraps around roller 211c.

The dual rollers may be arranged in various configurations within the housing. In some embodiments, the rollers may be positioned in a staggered or offset arrangement rather than directly side by side. This staggered configuration can enable for a more compact housing design, making the device less obtrusive when installed between seat portions. The housing shape may be customized to accommodate these offset rollers, potentially incorporating a stepped or contoured profile that efficiently encloses both rollers while maintaining a slim profile. Such configurations might feature a housing cross-section that provides adequate space for each roller while minimizing overall dimension size.

Each roller may incorporate its own spring mechanism, enabling for separate tension control and independent panel operation.

The dual roller configuration enables several deployment options. In one mode, handles 205 and 207 can be temporarily coupled, enabling simultaneous deployment of both panels, similar to the single roller configuration. Users can decouple the handles through a release mechanism, enabling independent panel control. This flexibility enables users to deploy only the panels needed for specific protection requirements. Each roller 211b and 211c operates with its own spring-loaded retraction device. When panels are retracted, they wrap around their respective rollers in a spiral configuration. The separation of panels onto dedicated rollers eliminates the need for layered wrapping, potentially reducing material stress and simplifying the retraction process. The individual spring mechanisms can be calibrated specifically for each panel's size and weight, optimizing deployment and retraction characteristics.

In scenarios where only partial coverage is needed, users can operate each panel independently. For example, if only seat bottom protection is required, the user can deploy second panel 204 using handle 207 while first panel 202 remains retracted on roller 211b. This independent operation may be particularly useful in situations requiring quick configuration changes or partial seat access.

In some embodiments, the dual roller system may also incorporate a synchronization mechanism that can be engaged when simultaneous panel operation is desired. This mechanism could include gear coupling between rollers 211b and 211c, ensuring coordinated movement when both panels are deployed together. When independent operation is needed, the synchronization can be disengaged through a user-accessible control, returning the system to independent roller operation.

FIG. 2F illustrates how the vehicle seat protection device 200 can be maintained. FIG. 2F illustrates the first panel 202 and second panel 204 in a fully extended state from opening 206, demonstrating accessibility for maintenance and cleaning. The panels can be extended to their maximum length, which is limited by internal stops within the housing that prevent complete removal, ensuring the panels remain securely attached to their respective retraction devices.

To facilitate maintenance operations, the vehicle seat protection device 200 may incorporate mechanisms to secure the panels in the extended position. In some embodiments, a locking system, such as integrated into the housing's end caps, may enables users to temporarily disable the retraction mechanism. This locking mechanism may take the form of a push-button or pull-pin that engages with the roller assembly to prevent rotation. When engaged, this mechanism holds the panels in the extended position without requiring the user to maintain tension against the spring force. In some embodiments, there may feature stopping points or notches along the roller circumference that engage with a locking component when the button is activated, securely holding the panels at the desired extension.

In some embodiments, there may be a two-stage extension system where the panels can be partially extended for normal use with automatic retraction capability. However, when pulled beyond a predetermined point, the panels engage a secondary locking mechanism that prevents retraction until deliberately released. This two-stage approach enables for convenient daily use while providing additional functionality for maintenance tasks. To release the panels from this locked maintenance position, users may need to perform a different operation, such as pulling the panels slightly further outward before enabling retraction, or manipulating a dedicated release control.

In this maintenance position, users can access the full surface area of both panels for cleaning. The extended configuration enables for thorough inspection of panel materials, attachment points, and any areas that may require attention. The panels can be cleaned using appropriate cleaning agents suitable for the specific material composition while remaining attached to the housing. Various cleaning methods may be employed based on panel materials and dirtying conditions. Surface cleaning can be performed using hoses, vacuum attachments, fabric cleaners, or damp cloths. For more thorough cleaning, users may use upholstery cleaning devices that can extract dirt and moisture while the panels remain extended. The panels' construction enables for adequate drying time in the extended position before retraction.

In some embodiments, resistance or water-repellent surface treatments may be reapplied during maintenance. These treatments can help maintain the protective properties of the panels while extending their service life.

The panels may incorporate different materials or surface textures on their protective and vehicle-contact sides. The maintenance position enables users to inspect and clean both surfaces, ensuring proper protection and preventing transfer of debris between the panel and vehicle upholstery. Any attachment features, such as headrest clips or bottom anchors, can also be inspected and cleaned in this position.

While the panels are configured to remain connected to the housing for security, the extended position enables access to the panel-to-roller connection points for inspection. These connection points may include reinforced sections that can be examined for wear while maintaining the integrity of the retraction system.

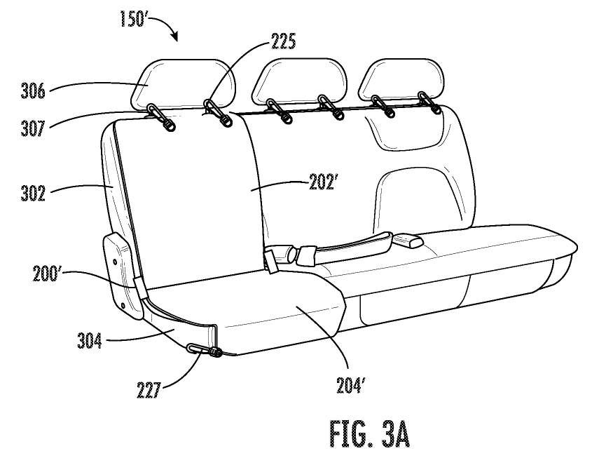

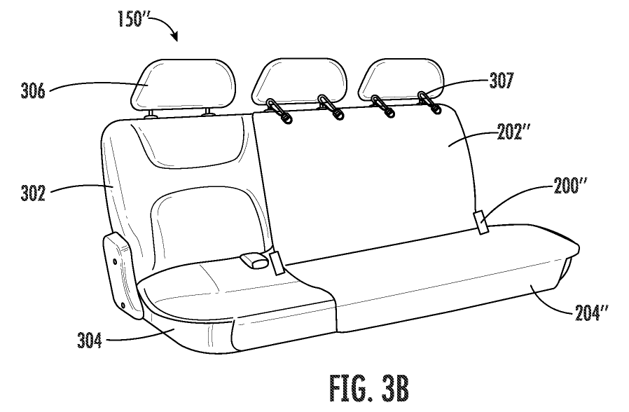

FIGS. 3A and 3B further illustrate how example protection devices can be configured to accommodate different seating arrangements and protect multiple seat positions in bench seat applications, providing flexibility for various transportation needs.

FIG. 3A illustrates a vehicle bench configuration 150' where the vehicle seat protection device 200' covers a single seat position. The device 200' includes components similar to those described in FIGS. 2A and 2B, with first panel 202' and second panel 204' providing coverage for an individual seating position. In this single-seat configuration, the vehicle seat protection device 200’ may utilize a housing sized specifically for individual seat coverage. This configuration enables passengers to occupy adjacent seats while maintaining protection for the designated protected seating area. The first panel 202' attaches to the headrest post using attachment feature 225, while the second panel 204' secures to the seat bottom using attachment feature 227, similar to the attachment mechanisms previously described.

The single-seat configuration may be particularly useful in vehicles with captain's chairs or where regular human passenger access is needed. This arrangement enables for efficient use of space while maintaining proper seat protection in the designated pet area.

FIG. 3B demonstrates a dual-seat configuration of the vehicle seat protection device 200'' installed on vehicle bench 150''. The device 200'' includes components similar to those described in FIGS. 2A and 2B. In this arrangement, the device 200'' extends to cover two adjacent seating positions, with first panel 202'' and second panel 204'' sized appropriately for the coverage area. This configuration provides protection across multiple seats while leaving one seat position available for passenger or other use. The dual-seat configuration may incorporate additional support structures within the panels to maintain proper coverage across the area. These supports could include reinforced sections or additional attachment points to prevent sagging or displacement during use. The panels may also feature intermediate attachment points to ensure consistent contact with the seat surfaces.

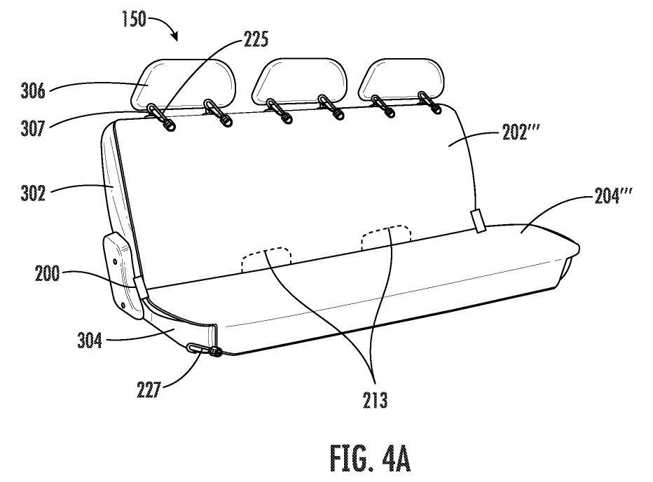

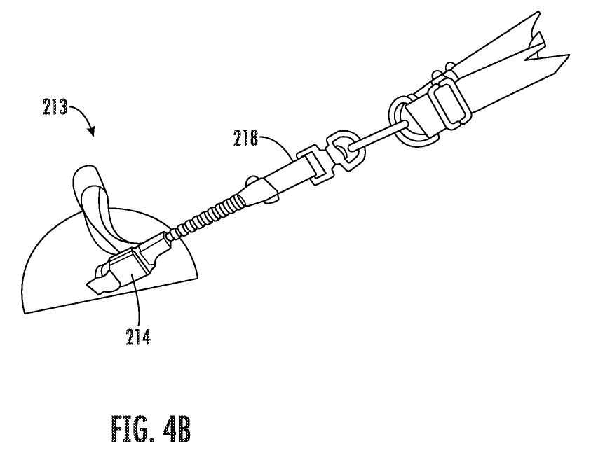

Both single-seat and dual-seat configurations can be configured to accommodate various vehicle interior layouts and seating arrangements. The protection device's adaptability to different seating configurations demonstrates its versatility in various vehicle applications. To further enhance its utility, the device may also incorporate specific features for pet safety and restraint. For example, FIGS. 4A and 4B illustrate how the protection device accommodates pet restraint systems while maintaining surface protection.

FIGS. 4A and 4B illustrate features that enable access to vehicle safety systems through the protective panels. FIG. 4A shows the vehicle seat protection device 200 with first panel 202’’’ and second panel 204’’’ fully extended, revealing access openings or ports 213. These access openings 213 are positioned to align with existing vehicle safety features, such as seat belt buckles and anchors, which are typically located at the intersection of the seat back portion 302 and seat bottom portion 304. The access openings 213 are integrated into the panel material during manufacturing and can be created through various construction methods. The openings may comprise precision-cut slits in the panel material with reinforced edges to prevent fraying or tearing. Users may be able separate the material at these slits to access the underlying vehicle safety features, and the material naturally returns to a closed position when not in use. The openings may also include closeable flaps or covers for the access openings 213 when not in use. These covers could be secured with hook-and-loop fasteners, snaps, or magnetic elements, providing additional protection when the ports are not needed.

The alignment of access openings 213 can be standardized based on common vehicle seat belt and anchor locations or customized for specific vehicle models. The openings may include visible markers or raised elements on the panel surface to help users locate them during use. These indicators can be colored or textured to provide both visual and tactile identification. The size and shape of the access openings are optimized to provide necessary access while minimizing exposure of the underlying seat surfaces.

In some embodiments, the access openings 213 may be constructed with various closure mechanisms to secure them when not in use. This may include zippers, hook and loop fasteners, snap fasteners, or overlapping fabric panels. These various closure mechanisms provide defined access points while maintaining full coverage capabilities.

FIG. 4B demonstrates the functionality of the access opening 213, showing how a seat belt buckle 214 can be accessed through the opening. The buckle 214 extends through the access opening, enabling attachment of a restraint attachment such as a pet restraint 218. This configuration enables users to secure pets using the vehicle's existing safety systems while maintaining seat protection. The access opening 213 can accommodate various types of restraint systems. Beyond traditional seat belt buckles, the openings may provide access to LATCH anchors, ISOFIX anchors, tether points, or other vehicle-specific restraint features. This versatility enables users to select appropriate restraint methods based on their pet's size and specific safety needs.

In some embodiments, the vehicle anchors used for securing the housing 209 (such as LATCH or ISOFIX points) are distinct and separate from the restraint attachment points accessed through the access openings 213. While, in some embodiments, both utilize existing vehicle safety features, they serve different functions - the housing anchors provide stable positioning for the protection device itself, while the restraint attachment points enable for securing pets or cargo separately through the panel material.

In some embodiments, the vehicle seat protection device 200 may incorporate separate, dedicated attachment features specifically configured for pet harnesses or cargo restraints. These could be integrated into the panels or housing and such dedicated attachment points would provide additional options for securing pets or cargo without relying on the vehicle's built-in restraint systems.

In some embodiments, the access openings 213 may be configured to accommodate multiple restraint attachments simultaneously, enabling for the secure restraint of multiple pets. The positioning and number of access ports can be configured to specific vehicle models and intended use cases.

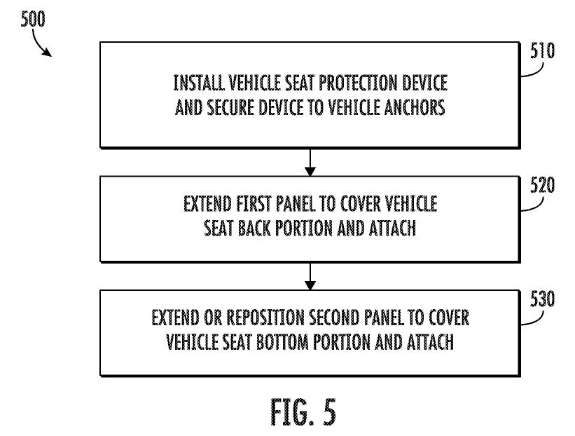

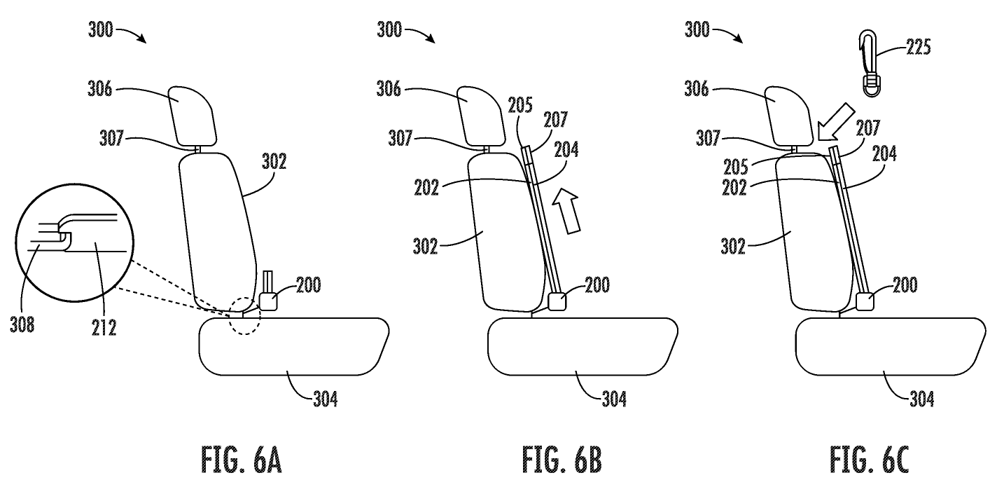

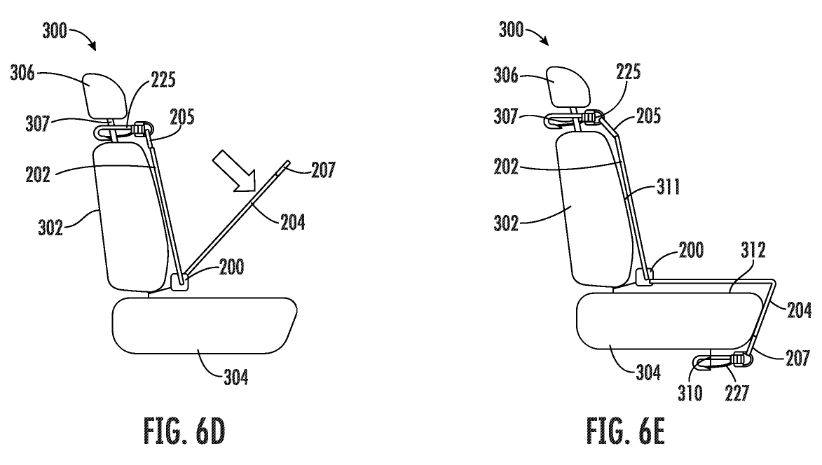

The previous sections have described the components and configurations of the vehicle seat protection device 200. FIG. 5 illustrates a flowchart 500 outlining the method for installing and securing the device while FIGS. 6A-6E provide detailed visual representations of each step in this installation process.

The installation method 500 begins with operation 510, which involves installing the protection device between the vehicle seat back portion and seat bottom portion and securing it to vehicle anchors. As shown in FIG. 6A, this initial positioning aligns latch clips 212 with vehicle anchor points 308, which may typically be LATCH anchors or ISOFIX anchors found in modern vehicles.In some embodiments, the vehicle seat protection device 200 is mounted or installed in a vehicle seat 300. The vehicle seat 300 includes the seat back portion 302 and the seat bottom portion 304. The vehicle seat 300 may be a single seat, a two person seat, or a bench. For example, when the vehicle seat 300 is a bench seat, the vehicle seat 300 is able to accommodate three or more people. The vehicle seat protection device 200 extends a width of the vehicle seat 300. As illustrated, the width of the vehicle seat 300 is perpendicular to the seat back portion 302 and a seat bottom portion 304.

The cut-out view in FIG. 6A details how latch clip 212 engages with anchor points 308. These clips may incorporate spring-loaded mechanisms that provide audible or tactile feedback when proper engagement is achieved. The clips can be configured with various securing mechanisms, such as push-button releases, lever actions, or rotating locks to accommodate different user preferences and vehicle configurations.

In some embodiments, alternative mounting configurations may utilize different attachment mechanisms based on vehicle design. These could include adjustable straps, hook systems, or custom brackets for vehicles without standard LATCH anchors or ISOFIX anchors. In some embodiments, the vehicle seat protection device 200 may be completely customized for specific vehicle models rather than using standardized attachment points. For example, mounting systems could be configured to attach to the outside of the seat back, wrap around seat structures, connect to seat frame components, or utilize custom-fabricated attachment points specific to particular vehicle makes and models. The mounting system, whether universal or custom, ensures stable positioning of the housing while accommodating panel deployment and use.

Operation 520 in the flowchart involves extending the first panel to cover the vehicle seat back portion and attaching it. FIG. 6B illustrates this step, showing how handles 205 and 207 are used to extend both panels upward simultaneously. The handles may be temporarily coupled during this phase, ensuring synchronized panel movement. The retraction device maintains appropriate tension during deployment, preventing panel sagging or misalignment. The synchronized upward deployment shown in FIG. 6B can be achieved through various coupling mechanisms between the handles. These may include mechanical latches, magnetic connections, or interlocking components that maintain temporary engagement while allowing for later separation when needed.

FIG. 6C demonstrates the completion of operation 520, where the first panel 202 is secured using attachment feature 225 to the headrest post 307. The attachment feature 225 may be configured with quick-connect features that enables for rapid engagement while ensuring secure connection. Various attachment feature configurations could include adjustable straps, spring-loaded clips, or hook-and-loop systems that accommodate different headrest post configurations. The attachment process shown in FIG. 6C may also incorporate guided alignment features that help users properly position the first panel 202. These features could include visual indicators, alignment tabs, or contoured attachment features that naturally guide the panel into proper position against the seat back portion 302.

Operation 530 of the flowchart involves extending or repositioning the second panel to cover the vehicle seat bottom portion and attaching it. FIG. 6D shows this transition phase, where the second panel 204 is detached from its coupled position with the first panel and guided downward. This movement may be facilitated by a release mechanism in the handles, enabling for controlled separation and positioning of the second panel 204 over the seat bottom portion 304. The panel separation process illustrated in FIG. 6D can be implemented through various mechanisms. Where the handles are coupled together, there may be a push-button release or sliding lock that disengages the handles. In some embodiments, the first and second handle may operate independently, where the second panel movement may be controlled entirely by its dedicated handle and retraction device.

FIG. 6E shows the final installation step, completing operation 530, where the second panel 204 is secured using attachment feature 227 to an anchor point 310. The anchor points 310 may be located underneath the seat bottom portion 304, providing secure attachment while maintaining a clean appearance. The attachment feature 227 can be configured with various engagement mechanisms similar to those described for the headrest attachment. As illustrated, the first panel 202 is in the extended state and covers a front surface 311 of the vehicle seat back portion 302. Similarly, the second panel 204 is in the extended state and covers a top surface 312 of the vehicle seat bottom portion 304.

The complete installation creates a comprehensive protection system where both panels maintain proper tension through their respective attachment points. The first panel 202 extends from the housing to the headrest posts 307, while the second panel 204 extends forward to cover the seat bottom portion 304, creating continuous protection across the seating surfaces.

It is worth noting that additional operations or variations may be included in the method 500, depending on the specific requirements of the installation or the design of the vehicle seat protection device 200 or the vehicle seat protection device 700. For example, the method 500 may include operations for preparing the vehicle seat surfaces before installation, such as cleaning the anchor points or adjusting headrest positions. Additionally, the method may involve operations for testing the security of the panels after attachment, ensuring proper tension and coverage of the seat surfaces. The method may also include steps for configuring the vehicle seat protection device 200 or the vehicle seat protection device 700 based on specific vehicle requirements, such as selecting appropriate coverage width for single seat or multiple seat arrangements. Additional operations might involve adjusting panel tension, verifying access port alignment with vehicle safety features, or testing pet restraint attachments.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

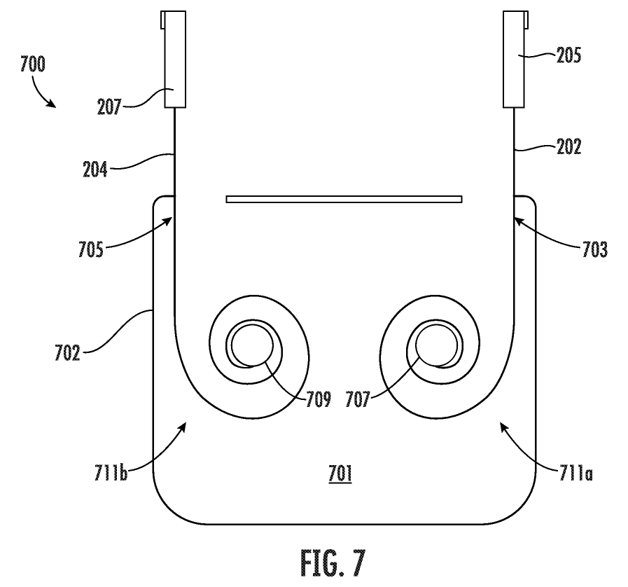

As noted herein, different configurations of vehicle seat protection devices are contemplated. For example, FIG. 7 illustrates an internal cross-sectional side view of another example vehicle seat protection device 700 showing a dual roller configuration, in accordance with some embodiments discussed herein.

The seat protection device 700 includes a retraction device 701 disposed in a housing 702. The retraction device 701 includes a first roller 711a and a second roller 711b. In this arrangement, the first panel 202 wraps around the first roller 711a and the second panel 204 independently wraps around the second roller 711b. The retraction device 701 stores the first panel 202 and the second panel 204 wrapped around their respective rollers 711a, 711b when the seat protection device 700 is in a retracted state.

The dual rollers may be arranged in various configurations within a housing 702. In some embodiments, the first roller 711a and the second roller 711b may be positioned in a staggered or offset arrangement rather than directly side by side. In some embodiments, the first roller 711a and the second roller 711b extend along at least about parallel axis. The housing 702 includes a first aperture 703 and a second aperture 705. The first aperture 703 and the second aperture 705 allow the first panel 202 and the second panel 204 to translate therethrough when the first panel 202 and the second panel 204 translate from the retracted state to an extended state. The housing may be configured such that the first aperture 703 is configured to allow the first panel 202 to translate therethrough and the second aperture 705 is configured to allow the second panel 204 to translate therethrough. For example, the first aperture 703 is disposed between the second aperture 705 and the vehicle seat back portion 302 (when installed).

The retraction device 701 includes a first spring 707 coupled to the first roller 711a and a second spring 709 coupled to the second roller 711b. Each roller incorporates its own spring mechanism, enabling for separate tension control and independent panel operation.

In some embodiments, the dual roller system may also incorporate a synchronization mechanism that can be engaged when simultaneous panel operation is desired. This mechanism could include gear coupling between rollers 711a, 711b, ensuring coordinated movement when both panels are deployed together. When independent operation is needed, the synchronization can be disengaged through a user-accessible control, returning the system to independent roller operation. Although some embodiments do not employ a synchronization mechanism.

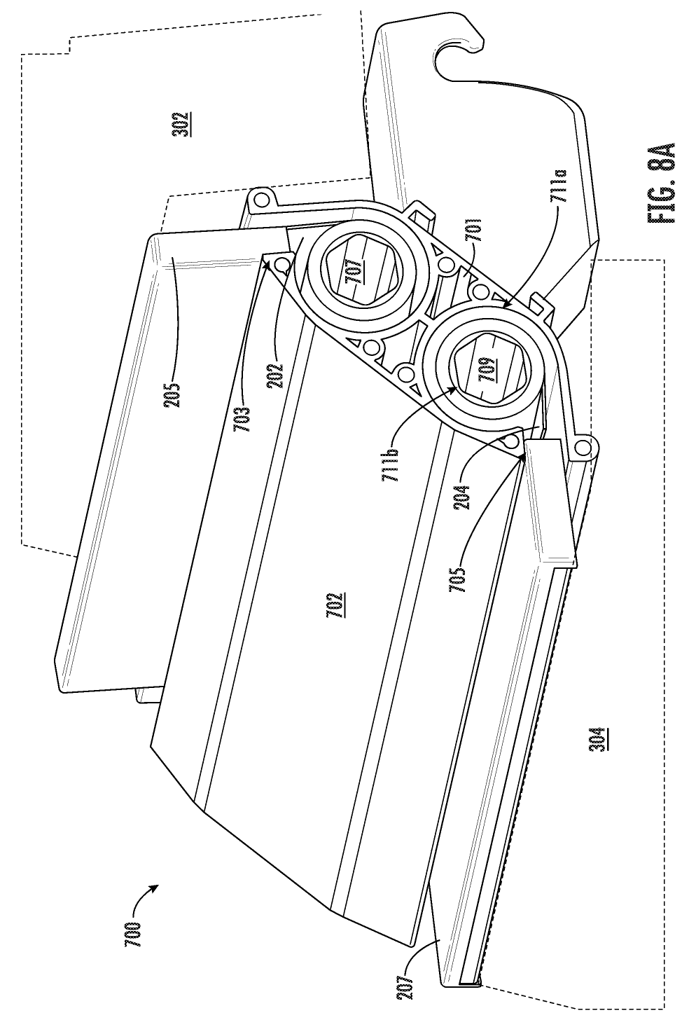

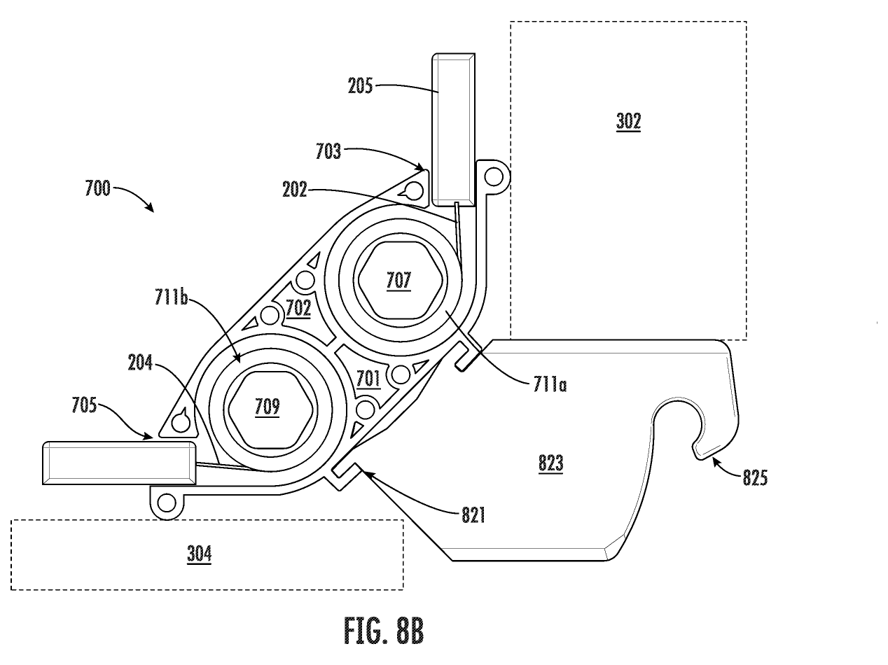

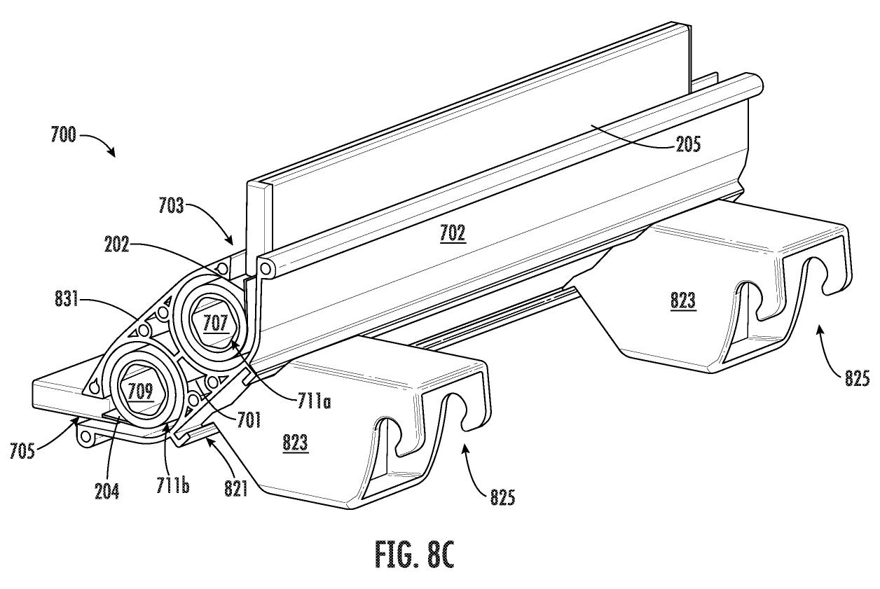

With reference to FIG. 8A, the housing 702 may incorporate a contoured or low-profile design that provides improved integration with vehicle seat geometry. In some embodiments, rather than a rectangular or box-shaped cross-section, the housing 702 may include curved or tapered surfaces that conform to the transition between the seat back portion 302 and seat bottom portion 304. This contoured profile reduces the protrusion of the housing 702 into the seating area, thereby minimizing interference with occupants or cargo while the device is installed. The reduced profile may enhance comfort when the device remains in place during normal vehicle use.

The positioning of the first aperture 703 and the second aperture 705 may be specifically configured to minimize gaps between the extending panels and the seat surfaces. By positioning the apertures such that the first panel 202 and second panel 204 exit the housing 702 at locations proximate to their respective seat surfaces, the configuration reduces or eliminates a "trampolining effect" where the panel material would span across a gap. Instead, the panels 202204 extend along paths that closely follow the seat contours, maintaining contact or near-contact with the seat surfaces throughout their deployed length. This aperture positioning ensures the protective panels conform to the seat geometry rather than bridging across open spaces.

FIG. 8A illustrates a perspective front view of the vehicle seat protection device 700, in accordance with some embodiments discussed herein. The second aperture 705 is configured to allow the second panel 204 to translate therethrough. The first aperture 703 is disposed between the second aperture 705 and the vehicle seat back portion 302.

FIG. 8B illustrates an internal cross-sectional side view of the vehicle seat protection device 700 of FIG. 8A. The housing 702 includes at least one housing attachment feature 821 configured to secure the housing 702 between the vehicle seat back portion 302 and the vehicle seat bottom portion 304. The housing attachment feature 821 allows the vehicle seat protection device 700 to mount to a housing attachment bracket 823. According to some embodiments, the housing attachment feature 821 may comprise a slotted geometry that allows for placement of the housing attachment bracket 823 along a width of the housing 702. The housing attachment bracket 823 may also include an attachment feature 825 that allows the bracket to be mounted onto hardware of the vehicle seat (such as described herein). In some embodiments, instead of the attachment feature 825, the housing attachment feature 821 may be configured to directly secure the housing 702 between the vehicle seat back portion 302 and the vehicle seat bottom portion 304. For example, the at least one attachment feature 821 may include one or more straps, one or more hooks, one or more clips, one magnets, one or more hook-and-loop fasteners, one or more snaps, or a combination thereof.

FIG. 8C illustrates a rear perspective view of the vehicle seat protection device 700 of FIG. 8A.The housing 702 shown in FIGS. 8A-8C may feature a contoured exterior profile or exterior surface 831 designed to integrate smoothly with vehicle seat geometry. The contoured design may include curved, tapered, convex, concave, or rounded surfaces that reduce the overall protrusion of the housing 702 when installed between the seat back portion 302 and seat bottom portion 304 of the vehicle seat 300. This low-profile configuration minimizes the distance the housing extends into the seating area, providing improved comfort and aesthetics when the device remains installed during vehicle use. The housing 702 may be constructed from materials such as molded plastic or formed aluminum that enable the creation of such contoured profiles while maintaining structural integrity.

The housing attachment brackets 823 are disposed opposite the exterior surface 831. In some embodiments, the housing attachment brackets 823 are placed into the vehicle seat 300 for mounting so as to allow the housing 702 to sit flush between the seat back portion 302 and seat bottom portion 304 of the vehicle seat 300.

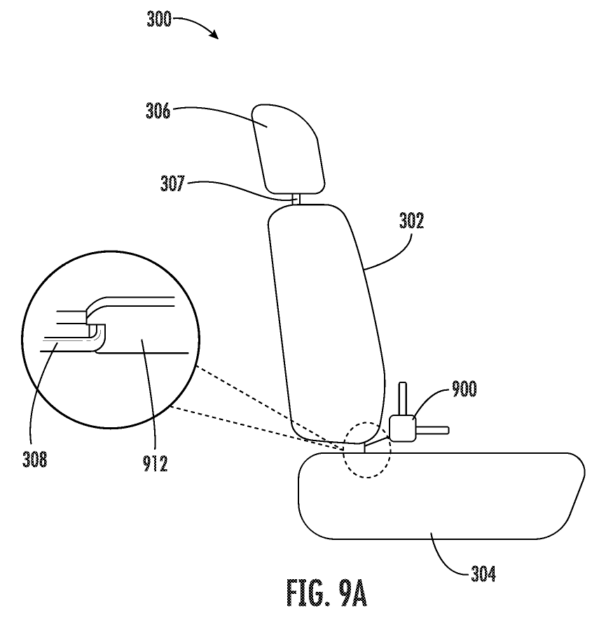

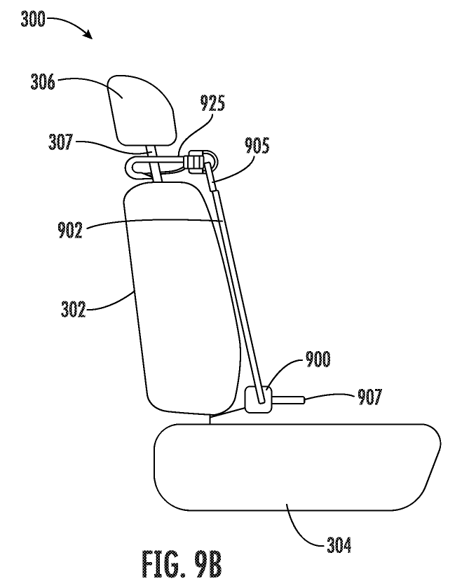

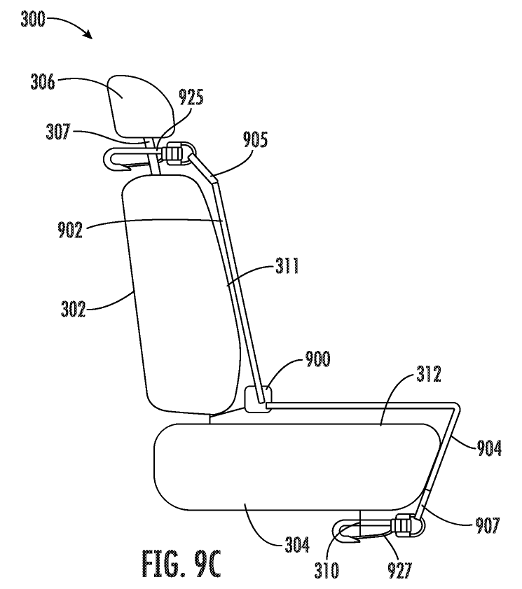

FIGS. 9A-9C provide detailed visual representations of the installation process for an example vehicle seat protection device, such as the protection device 700 illustrated in FIGS. 8A-8C.

As shown in FIG. 9A, this initial positioning aligns latch clips 912 with vehicle anchor points 308, which may typically be LATCH anchors or ISOFIX anchors found in modern vehicles.In some embodiments, the vehicle seat protection device 900 is mounted or installed in a vehicle seat 300. The vehicle seat 300 includes the seat back portion 302 and the seat bottom portion 304. The vehicle seat 300 may be a single seat, a two person seat, or a bench. For example, when the vehicle seat 300 is a bench seat, the vehicle seat 300 is able to accommodate three or more people. The vehicle seat protection device 200 extends a width of the vehicle seat 300. As illustrated, the width of the vehicle seat 300 is perpendicular to the seat back portion 302 and a seat bottom portion 304.

The cut-out view in FIG. 9A details how latch clip 912 engages with anchor points 308. These clips may incorporate spring-loaded mechanisms that provide audible or tactile feedback when proper engagement is achieved. The clips can be configured with various securing mechanisms, such as push-button releases, lever actions, or rotating locks to accommodate different user preferences and vehicle configurations.

In some embodiments, alternative mounting configurations may utilize different attachment mechanisms based on vehicle design. These could include adjustable straps, hook systems, or custom brackets for vehicles without standard LATCH anchors or ISOFIX anchors. In some embodiments, the vehicle seat protection device 900 may be completely customized for specific vehicle models rather than using standardized attachment points. For example, mounting systems could be configured to attach to the outside of the seat back, wrap around seat structures, connect to seat frame components, or utilize custom-fabricated attachment points specific to particular vehicle makes and models. The mounting system, whether universal or custom, ensures stable positioning of the housing while accommodating panel deployment and use.

FIG. 9B illustrates how handle 905 is used to extend the first panel 902 upward for attachment of an attachment feature 925, such as to a headrest post 307 so that the first panel 902 is extended and attached so as to cover the front surface 311 of the seat back portion 302.

FIG. 9C illustrates how handle 907 is used to extend the second panel 904 horizontally for attachment of an attachment feature 927, such as to an anchor point 310 under the seat bottom portion 304 so that the second panel 904 is extended and attached so as to cover the top surface 312 of the seat bottom portion 304.

The complete installation creates a comprehensive protection system where both panels maintain proper tension through their respective attachment points. The first panel 902 extends upwardly to cover the seat back portion 302, while the second panel 904 extends forward to cover the seat bottom portion 304, creating continuous protection across the seating surfaces.

### CONCLUSION

Many modifications and other embodiments of the disclosures set forth herein will come to mind to one skilled in the art to which these present disclosures pertain having the benefit of the teachings presented in the foregoing descriptions and the associated drawings. Therefore, it is to be understood that the embodiments of the present disclosure are not to be limited to the specific embodiments disclosed and that modifications and other embodiments are intended to be included within the scope of the present disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the present disclosure. In this regard, for example, different combinations of elements and/or functions than those explicitly described above are also contemplated within the scope of the present disclosure. Although specific terms are employed herein, they are used in a generic and descriptive sense only and not for purposes of limitation.

What is claimed is:

1. A vehicle seat protection device comprising:
a housing;
a first panel at least partially disposed in the housing when in a retracted state;
a second panel at least partially disposed in the housing when in the retracted state;
a retraction device disposed in the housing, the retraction device comprising:
a first roller, the first panel coupled to the first roller in the retracted state; and
a first spring configured to apply a first rotational force on the first roller that biases the first panel into the retracted state; and
at least one first attachment feature coupled to the first panel, wherein the at least one first attachment feature is configured to attach to an upper portion of a vehicle seat back portion, wherein, when the at least one first attachment feature is attached to the upper portion of the vehicle seat back portion, the first panel is in the extended state and covers a front surface of the vehicle seat back portion.

2. The vehicle seat protection device of claim 1, further comprising:
at least one second attachment feature coupled to the second panel, wherein the at least one second attachment feature is configured to attach to a lower portion of the vehicle seat back portion, wherein, when the at least one second attachment feature is attached to the lower portion of the vehicle seat back portion, the second panel is in the extended state and covers a top surface of the vehicle seat back portion.

3. The vehicle seat protection device of claim 1, wherein the retraction device further comprises:
a second roller disposed in the housing, the second panel coupled to the second roller in the retracted state; and
a second spring, the second spring configured to apply a second rotational force on the second roller that biases the second panel into the retracted state.

4. The vehicle seat protection device of claim 3, wherein the first roller is disposed in the housing adjacent to the second roller.

5. The vehicle seat protection device of claim 1, wherein the first panel and the second panel comprise one or more access openings configured to provide access to restraint attachment points, the one or more access openings aligned with one or more vehicle seat buckles or latches when the first panel is deployed, the one or more access openings comprising closeable slits in the first panel.

6. The vehicle seat protection device of claim 1, further comprising:
a locking mechanism configured to selectively prevent retraction of at least one of the first panel or the second panel when in the extended state; and
a button that engages with the locking mechanism to prevent the retraction device from retracting the first panel and the second panel.

7. The vehicle seat protection device of claim 1, further comprising:
a two-stage extension system, wherein the two-stage extension system comprises:
a first extension stage, wherein the first panel and the second panel extend to a first position and wherein the first panel and the second panel are configured to automatically retract when released from the first position; and
a second extension stage, wherein the first panel and the second panel extend beyond the first position to a second position, wherein a locking feature engages with the retraction device to prevent automatic retraction of the first panel and second panel in the second position.

8. The vehicle seat protection device of claim 1, wherein the housing comprises at least one housing attachment feature configured to secure the housing between a vehicle seat back portion and a vehicle seat bottom portion.

9. The vehicle seat protection device of claim 1, wherein the first roller of the retraction device is configured to retract both the first panel and the second panel.

10. The vehicle seat protection device of claim 1, wherein the housing comprises a first handle for deploying the first panel and a second handle for deploying the second panel, the first handle configured to simultaneously deploy both the first panel and the second panel.

11. The vehicle seat protection device of claim 1, wherein the first panel and the second panel comprise a material, wherein the material comprises at least one of nylon, polyester, canvas, vinyl, leather, polypropylene, or other polymers.

12. The vehicle seat protection device of claim 1, wherein the housing comprises:
a first aperture configured to allow the first panel to translate therethrough; and
a second aperture configured to allow the second panel to translate therethrough, the first aperture disposed between the second aperture and a vehicle seat back portion.

13. A vehicle seat protection device comprising:
a housing;
a first panel disposed in the housing while in a retracted state;
a second panel disposed in the housing while in a retracted state;
a retraction device disposed in the housing, the retraction device comprising:
a first roller coupled to the first panel;
a first spring configured to apply a first rotational force to the first roller that biases the first panel into the retracted state;
a second roller coupled to the second panel; and
a second spring configured to apply a second rotational force to the second roller that biases the second panel into the retracted state;
at least one first attachment feature coupled to the first panel, wherein the at least one first attachment feature is configured to attach to an upper portion of a vehicle seat back portion when the first panel is in the extended state, wherein the at least one first attachment feature is attached to the upper portion of the vehicle seat back portion and covers a front surface of the vehicle seat back portion when the first panel is in the extended state; and
at least one second attachment feature coupled to the second panel, wherein the at least one second attachment feature is configured to attach to a lower portion of the vehicle seat back portion, wherein, when the at least one second attachment feature is attached to the lower portion of the vehicle seat back portion, the second panel is in the extended state and covers a top surface of the vehicle seat back portion.

14. The vehicle seat protection device of claim 13, wherein the housing comprises:
a first aperture configured to allow the first panel to translate therethrough; and
a second aperture configured to allow the second panel to translate therethrough, the first aperture disposed between the second aperture and the vehicle seat back portion.

15. The vehicle seat protection device of claim 13, wherein the housing comprises at least one housing attachment feature configured to attach to at least one anchoring point of the vehicle seat back portion.

16. The vehicle seat protection device of claim 13, wherein the first panel and the second panel are in an adjacent spiral configuration within the housing when in the retracted state.

17. A vehicle seat assembly comprising:
a vehicle seat comprising a seat back portion and a seat bottom portion;
a seat protection device positioned between the seat back portion and the seat bottom portion, the seat protection device comprising:
a housing;
a retraction device;
a first panel at least partially stored in the housing when in a retracted state, the first panel coupled to the retraction device, wherein the first panel is configured to extend from the housing when in an extended state and retract into the housing when in the retracted state, the first panel covering a front surface of the vehicle seat back portion in the extended state;
a second panel at least partially stored in the housing when in the retracted state, the second panel coupled to the retraction device, wherein the second panel is configured to extend from the housing when in the extended state and retract into the housing when in the retracted state, the second panel covering a top surface of the vehicle seat bottom portion in the extended state;
at least one first attachment feature configured to attach to an upper portion of the vehicle seat back portion when in the extended state; and
at least one second attachment feature, configured to attach to the vehicle seat bottom portion, when in the extended state.

18. The vehicle seat assembly of claim 17, wherein the retraction device is disposed in the housing and the retraction device comprises:
a first roller coupled to the first panel;
a first spring configured to apply a first rotational force to the first roller that biases the first panel into the retracted state;
a second roller coupled to the second panel; and
a second spring configured to apply a second rotational force to the second roller that biases the second panel into the retracted state.

19. The vehicle seat assembly of claim 17, wherein the housing comprises:
a first aperture configured to allow the first panel to translate therethrough; and
a second aperture configured to allow the second panel to translate therethrough, the first aperture disposed between the second aperture and the vehicle seat back portion.

20. The vehicle seat assembly of claim 17, wherein the first panel and the second panel are configured to be independently deployable from the housing.
